(19) United States
(12) Patent Application Publication
(10) Pub. No.: US 2025/0280455 A1
(43) Pub. Date: Sep. 4, 2025

(54) ELECTRONIC DEVICE AND METHOD FOR PERFORMING DIRECT COMMUNICATION

(71) Applicant: SAMSUNG ELECTRONICS CO., LTD., Suwon-si (KR)

(72) Inventors: Sumaiya SULTANA, Dhaka (BD); Mahmud Muntakim KHAN, Dhaka (BD); Mahbubul HAQUE, Dhaka (BD)

(73) Assignee: SAMSUNG ELECTRONICS CO., LTD., Suwon-si (KR)

(21) Appl. No.: 19/066,962

(22) Filed: Feb. 28, 2025

(30) Foreign Application Priority Data
Feb. 29, 2024 (KR) 10-2024-0029563

(51) Int. Cl. H04W 76/14; H04W 76/25; H04W 76/30; H04W 92/16

(52) U.S. Cl. CPC H04W 76/14; H04W 76/25; H04W 76/30; H04W 92/16

(57) ABSTRACT

An electronic device may include: a Bluetooth communication interface; a Wi-Fi interface; memory storing instructions; and at least one processor configured to execute the instructions, wherein the instructions, when executed by the at least one processor individually or collectively, cause the electronic device to: identify Wi-Fi pairing state information related to a Wi-Fi direct connection between an external electronic device and the electronic device; transmit a pairing state request including electronic device pairing state information about the electronic device to the external electronic device through the Bluetooth communication interface; receive a pairing state response to the pairing state request from the external electronic device through the Bluetooth communication interface, the pairing state response including external electronic device pairing state information about the external electronic device; and compare the external electronic device pairing state information and the electronic device pairing state information to generate a comparison result.

### CROSS-REFERENCE TO RELATED APPLICATION(S)

This application is based on and claims priority under 35 U.S.C. § 119 to Korean Patent Application No. 10-2024-0029563, filed on Feb. 29, 2024, in the Korean Intellectual Property Office, the disclosure of which is incorporated by reference herein in its entirety.

### BACKGROUND

### 1. Field

The disclosure relates to an electronic device performing direct communication and a method for operating the same.

### 2. Description of Related Art

Wi-Fi direct technology may provide direct communication of Wi-Fi-enabled devices via a peer-to-peer (P2P) protocol connection without a network infrastructure device (e.g., an access point or router).

Display devices with a display (including, e.g., TVs) as well as portable devices (e.g., smartphones, mobile phones, personal digital assistants (PDAs), tablet personal computers (PCs), laptop PCs, digital schedulers, digital dictionaries, or MP3 players) may mutually transmit or share content (e.g., text, images, videos, games, or documents) through Wi-Fi direct technology.

### SUMMARY

According to an aspect of the disclosure, an electronic device includes: a Bluetooth communication interface; a Wi-Fi interface; memory storing instructions; and at least one processor configured to execute the instructions, wherein the instructions, when executed by the at least one processor individually or collectively, cause the electronic device to: identify Wi-Fi pairing state information related to a Wi-Fi direct connection between an external electronic device and the electronic device; transmit a pairing state request including electronic device pairing state information about the electronic device to the external electronic device through the Bluetooth communication interface; receive a pairing state response to the pairing state request from the external electronic device through the Bluetooth communication interface, the pairing state response including external electronic device pairing state information about the external electronic device; compare the external electronic device pairing state information and the electronic device pairing state information to generate a comparison result; release the Wi-Fi direct connection between the external electronic device and the electronic device based on the comparison result; generate a new group for a new Wi-Fi direct connection to the external electronic device; and establish a Wi-Fi direct peer-to-peer (P2P) connection with the external electronic device through the Wi-Fi interface, based on the generated new group.

According to an aspect of the disclosure, a method performed by an electronic device, includes: identifying Wi-Fi pairing state information related to a Wi-Fi direct connection between an external electronic device and the electronic device; transmitting a pairing state request including electronic device pairing state information about the electronic device to the external electronic device through a Bluetooth communication interface; receiving a pairing state response to the pairing state request from the external electronic device through the Bluetooth communication interface, the pairing state response including external electronic device pairing state information about the external electronic device; comparing the external electronic device pairing state information and the electronic device pairing state information to generate a comparison result; releasing the Wi-Fi direct connection between the external electronic device and the electronic device based on the comparison result; generating a new group for a new Wi-Fi direct connection to the external electronic device; and establishing a Wi-Fi direct peer-to-peer (P2P) connection with the external electronic device through a Wi-Fi interface, based on the generated new group.

According to an aspect of the disclosure, a non-transitory computer-readable storage medium stores one or more programs including instructions to, when executed by at least one processor of an electronic device individually or collectively, cause the electronic device to: identify Wi-Fi pairing state information related to a Wi-Fi direct connection between an external electronic device and the electronic device; transmit a pairing state request including electronic device pairing state information about the electronic device to the external electronic device through a Bluetooth communication interface; receive a pairing state response to the pairing state request from the external electronic device through the Bluetooth communication interface, the pairing state response including external electronic device pairing state information about the external electronic device; compare the external electronic device pairing state information and the electronic device pairing state information to generate a comparison result; release the Wi-Fi direct connection between the external electronic device and the electronic device based on the comparison result; generate a new group for a new Wi-Fi direct connection to the external electronic device; and establish a Wi-Fi direct peer-to-peer (P2P) connection with the external electronic device through a Wi-Fi interface, based on the generated new group.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an electronic device in a network environment according to various embodiments;

FIG. 2 is a block diagram illustrating a system configuration for describing a communication connection according to one or more embodiments;

FIG. 3 is a view illustrating a P2P group formation and file transmission procedure according to one or more embodiments;

FIG. 4 is a view illustrating device-to-device negotiation in a standard group formation procedure according to one or more embodiments;

FIG. 5A is a view illustrating, in greater detail, a P2P group formation procedure according to one or more embodiments;

FIG. 5B is a view illustrating, in greater detail, a P2P group formation procedure according to one or more embodiments;

FIG. 5C is a view illustrating, in greater detail, a P2P group formation procedure according to one or more embodiments;

FIG. 6A is a view illustrating an example of Wi-Fi direct connection based on autonomous group formation;

FIG. 6B is a view illustrating an example of Wi-Fi direct connection based on autonomous group formation;

FIG. 7 is a view illustrating an example of Wi-Fi direct connection based on persistent group formation according to one or more embodiments;

FIG. 8A is a view illustrating an example of using a persistent group formation procedure in subsequent connection between electronic devices according to one or more embodiments;

FIG. 8B is a view illustrating an example of using a persistent group formation procedure in subsequent connection between electronic devices according to one or more embodiments;

FIG. 8C is a view illustrating an example of using a persistent group formation procedure in subsequent connection between electronic devices according to one or more embodiments;

FIG. 9A is a view illustrating another example of using a persistent group formation procedure in subsequent connection between electronic devices according to one or more embodiments;

FIG. 9B is a view illustrating another example of using a persistent group formation procedure in subsequent connection between electronic devices according to one or more embodiments;

FIG. 9C is a view illustrating another example of using a persistent group formation procedure in subsequent connection between electronic devices according to one or more embodiments;

FIG. 10 is a view illustrating a persistent group formation procedure according to one or more embodiments;

FIG. 11A is a sequence diagram illustrating a persistent group formation procedure according to one or more embodiments;

FIG. 11B is a sequence diagram illustrating a persistent group formation procedure according to one or more embodiments;

FIG. 12A is a view illustrating an example of using a persistent group formation procedure in subsequent connection between electronic devices according to one or more embodiments;

FIG. 12B is a view illustrating an example of using a persistent group formation procedure in subsequent connection between electronic devices according to one or more embodiments;

FIG. 13A is a view illustrating an example of using a persistent group formation procedure in subsequent connection between electronic devices according to one or more embodiments; and

FIG. 13B is a view illustrating an example of using a persistent group formation procedure in subsequent connection between electronic devices according to one or more embodiments.

### DETAILED DESCRIPTION

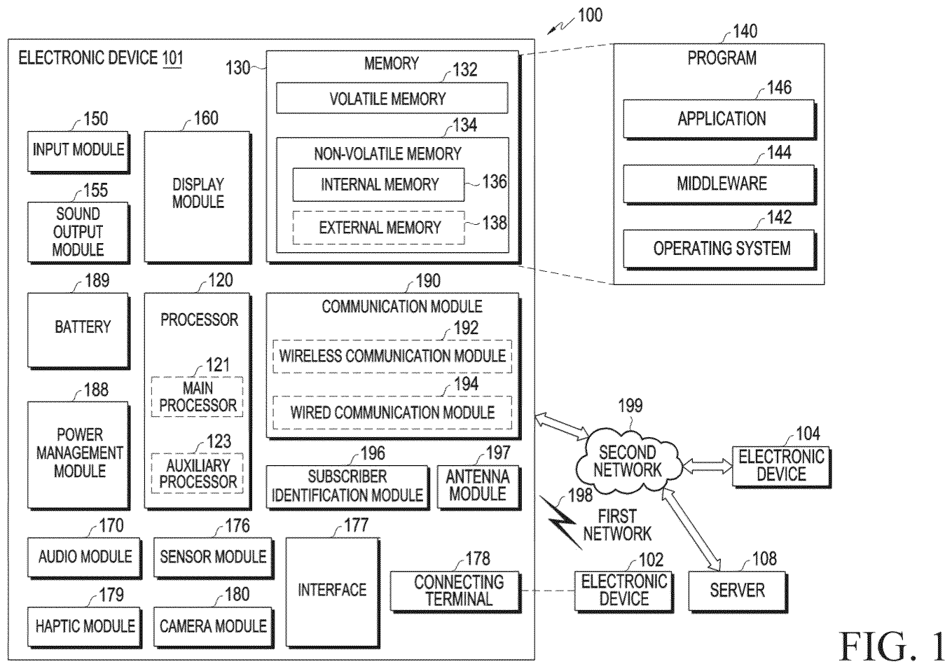

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to one or more embodiments, the electronic device 101 may communicate with the electronic device 104 via the server 108. According to one or more embodiments, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In one or more embodiments, at least one (e.g., the connecting terminal 178) of the components may be omitted from the electronic device 101, or one or more other components may be added in the electronic device 101. According to one or more embodiments, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one or more embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to one or more embodiments, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one or more embodiments, the auxiliary processor 123 (e.g., an image signal processor or a communication processor) may be implemented as part of another component (e.g., the camera module 180 or the communication module 190) functionally related to the auxiliary processor 123. According to one or more embodiments, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to one or more embodiments, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to one or more embodiments, the display 160 may include a touch sensor configured to detect a touch, or a pressure sensor configured to measure the intensity of a force generated by the touch.

The audio module 170 may convert a sound into an electrical signal and vice versa. According to one or more embodiments, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to one or more embodiments, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to one or more embodiments, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to one or more embodiments, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to one or more embodiments, the haptic module 179 may include, for example, a motor, a piezoelectric element, or an electric stimulator.

The camera module 180 may capture a still image or moving images. According to one or more embodiments, the camera module 180 may include one or more lenses, image sensors, image signal processors, or flashes.

The power management module 188 may manage power supplied to the electronic device 101. According to one or more embodiments, the power management module 188 may be implemented as at least part of, for example, a power management integrated circuit (PMIC).

The battery 189 may supply power to at least one component of the electronic device 101. According to one or more embodiments, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to one or more embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to one or more embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to one or more embodiments, the antenna module 197 may include one antenna including a radiator formed of a conductor or conductive pattern formed on a substrate (e.g., a printed circuit board (PCB)). According to one or more embodiments, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to one or more embodiments, other parts (e.g., radio frequency integrated circuit (RFIC)) than the radiator may be further formed as part of the antenna module 197.

According to various embodiments, the antenna module 197 may form a mmWave antenna module. According to one or more embodiments, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one or more embodiments, instructions or data may be transmitted or received between the electronic device 101 and the external electronic device 104 via the server 108 coupled with the second network 199. The external electronic devices 102 or 104 each may be a device of the same or a different type from the electronic device 101. According to one or more embodiments, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or application-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to one or more embodiments, the external electronic device 104 or the server 108 may be included in the second network 199. The electronic device 101 may be applied to intelligent services (e.g., smart home, smart city, smart car, or health-care) based on 5G communication technology or IoT-related technology.

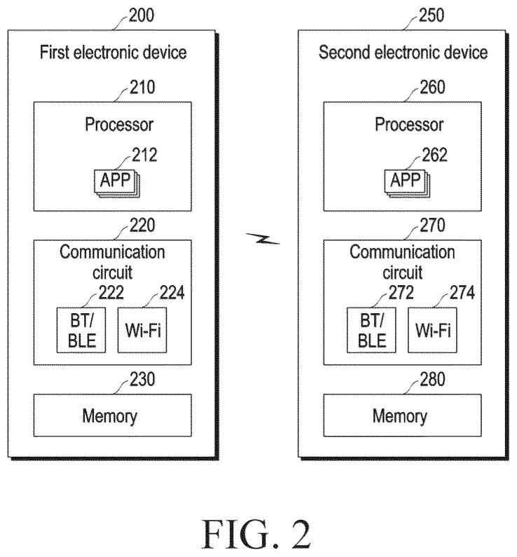

FIG. 2 is a block diagram illustrating a system configuration for describing a communication connection according to one or more embodiments.

Referring to FIG. 2, a first electronic device 200 (e.g., the electronic device 101) may communicate with a second electronic device 250 (e.g., the electronic device 101) using a wireless communication technology or a wired communication technology. In one or more embodiments, the first electronic device 200 (e.g., the electronic device 101) and the second electronic device 250 (e.g., the electronic device 101) may be configured to support at least one of peer-to-peer (P2P) communication based on Wi-Fi direct, Bluetooth legacy (BT), Bluetooth low energy (BLE), a network interface, an autonomous group owner of a P2P connection, a multi device experience (MDE), a networking protocol, or wireless communication.

The first electronic device 200 (e.g., the electronic device 101 of FIG. 1) may include at least one processor 210 (e.g., the processor 120 of FIG. 1), a communication circuit 220 (e.g., the wireless communication module 192 of FIG. 1), and/or memory 230 (e.g., the memory 130 of FIG. 1).

In one or more embodiments, the communication circuit 220 of the first electronic device 200 may include a communication module or interface (e.g., a BT/BLE module (or BT/BLE interface) 222) for supporting Bluetooth legacy and/or BLE and/or a communication module (e.g., a Wi-Fi module (or Wi-Fi interface) 224) for supporting Wi-Fi. The BT/BLE module 222 and/or the Wi-Fi module 224 may include one or more communication components for transmitting/receiving signals to/from an external electronic device (e.g., the second electronic device 250) using the one or more antennas. In one or more embodiments, one or two or more antennas may be implemented as part of the antenna module 197 of FIG. 1. According to one or more embodiments, the communication circuit 220 may support communication based on a BT and/or BLE (hereinafter, referred to as BT/BLE) scheme and/or a Wi-Fi scheme using the BT/BLE communication module 222 (Bluetooth interface) and/or the Wi-Fi module 224.

The processor 210 (e.g., the processor 120 of FIG. 1) that may be implemented as one or more single-core processors or one or more multi-core processors, and memory 230 (e.g., the memory 130 of FIG. 1) that stores instructions for the operation of the first electronic device 200.

According to embodiments, the memory 230 may store instructions or related data for negotiating a frequency band and a group owner (GO) for Wi-Fi direct-based P2P communication using BT/BLE. According to embodiments, the processor 210 may execute at least one application (e.g., application (APP) 212) based on Wi-Fi direct communication, and may control the communication circuit 220 (e.g., the BT/BLE module 222 and/or the Wi-Fi module 224) according to the execution of the application 212.

The second electronic device 250 (e.g., the electronic device 101 of FIG. 1) may include at least one processor 260 (e.g., the processor 120 of FIG. 1), a communication circuit 270 (e.g., the wireless communication module 192 of FIG. 1), and/or memory 280 (e.g., the memory 130 of FIG. 1).

In one or more embodiments, the communication circuit 270 of the second electronic device 250 may include a communication module (e.g., a BT/BLE module 272) for supporting Bluetooth legacy and/or BLE and/or a communication module (e.g., a Wi-Fi communication module 274) for supporting Wi-Fi. The BT/BLE module 272 and/or the Wi-Fi module 274 may include one or more communication components for transmitting/receiving signals to/from an external electronic device (e.g., the first electronic device 200) using one or more antennas. In one or more embodiments, one or two or more antennas may be implemented as part of the antenna module 197 of FIG. 1. According to one or more embodiments, the communication circuit 270 may support communication based on a BT and/or BLE (hereinafter, referred to as BT/BLE) scheme and/or a Wi-Fi scheme using the BT/BLE module 272 and/or the Wi-Fi module 274.

The second electronic device 250 may include a processor 260 (e.g., the processor 120 of FIG. 1) that may be implemented as one or more single-core processors or one or more multi-core processors, and memory 280 (e.g., the memory 130 of FIG. 1) that stores instructions for operating the second electronic device 250.

According to embodiments, the memory 280 may store instructions or related data for negotiating a frequency band and a group owner (GO) for Wi-Fi direct-based P2P communication using BT/BLE. According to embodiments, the processor 260 may execute at least one application (e.g., the application (APP) 262) based on Wi-Fi direct communication, and may control the communication circuit 270 (e.g., the BT/BLE module 272 and/or the Wi-Fi module 274) according to the execution of the application 262.

P2P communication using Wi-Fi direct is becoming ubiquitous due to high bandwidth, short latency, and minimum packet loss in a multi-device environment, and the first electronic device 200 and the second electronic device 250 may communicate directly with each other using Wi-Fi direct without a central access point (AP). In one or more embodiments, at least one of the first electronic device 200 or the second electronic device 250 may include at least one of a mobile phone, a camera, a printer, a personal computer (PC), or a game device, and may generate its own Wi-Fi network without an Internet connection using Wi-Fi direct.

The first electronic device 200 and the second electronic device 250 may be connected to each other through a P2P group including one or more external electronic devices connected one-to-one or simultaneously, and thus may quickly and easily transmit, display, play, or share content.

As the demand for device-to-device communication increases, the first electronic device 200 and the second electronic device 250 may provide a reliable and stable P2P connection so that the user may experience a satisfactory connection between devices anytime, anywhere.

The first electronic device 200 and the second electronic device 250 may use a Wi-Fi P2P channel for services using device-to-device communication. In one or more embodiments, services using device-to-device communication may include at least one of file sharing, screen mirroring, a second screen, multi-control for sharing peripheral devices (e.g., a keyboard and/or a mouse) between devices, an auto switch, or a continuity service supporting simultaneous connection between devices. The services may be based on device-to-device communication using a P2P connection.

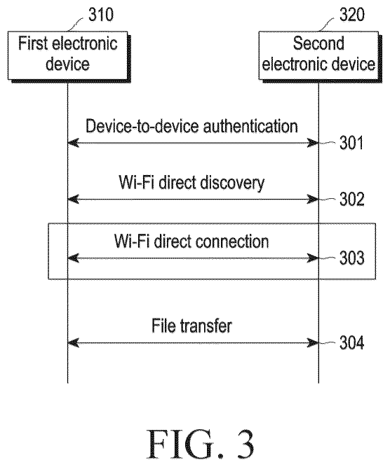

FIG. 3 is a view illustrating a P2P group formation and file transmission procedure according to one or more embodiments.

Referring to FIG. 3, in operation 301, the first electronic device 310 (e.g., a notebook PC) and the second electronic device 320 (e.g., a mobile phone) may determine to start Wi-Fi direct communication and may perform a mutual device-to-device authentication procedure. As an example, the first electronic device 200 (e.g., the processor 210) may determine to initiate Wi-Fi direct communication based on execution of an application (e.g., a file sharing application, a multi-control application, or a continuity application) requiring Wi-Fi direct communication. In one or more embodiments, the mutual device-to-device authentication procedure may use a generic attribute profile (GATT) as a method for exchanging a profile and data through a BLE connection. The mutual device-to-device authentication procedure may take 1 to 2 seconds.

In operation 302, the first electronic device 310 and the second electronic device 320 may perform a search for a Wi-Fi direct connection. In the Wi-Fi direct search operation, each of the first electronic device 310 and the second electronic device 320 may find a counterpart device and establish a channel. Wi-Fi direct search may take 2 to 3 seconds.

In operation 303, the first electronic device 310 and the second electronic device 320 may perform a Wi-Fi direct connection. A P2P group may be formed in the Wi-Fi direct connection operation. The Wi-Fi direct connection may take 2 to 4 seconds.

As a method for forming a P2P group for Wi-Fi direct connection in operation 303, a standard group formation procedure, an autonomous group formation procedure, a persistent group formation procedure, or the like may be used.

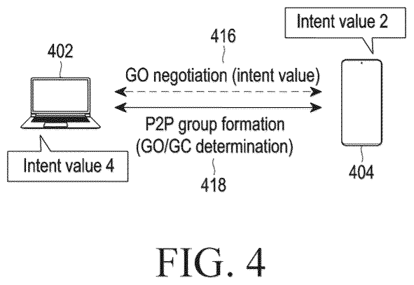

FIG. 4 is a view illustrating device-to-device negotiation in a standard group formation procedure according to one or more embodiments.

Referring to FIG. 4, electronic devices (e.g., the electronic device 410 and the electronic device 420) may perform group owner negotiation/selection to establish a P2P connection based on Wi-Fi direct.

In the P2P group, the group owner may allocate a P2P interface address, select an operation channel of the group, and transmit a beacon signal including various operation parameters of the group. Only the group owner may transmit the beacon signal within the P2P group, which allows the P2P device to quickly identify the group owner and participate in the group in the scan stage, which is the initial stage of connection. Further, the group owner may start the P2P group session on his own.

At time T1, the electronic device 402 (e.g., a notebook PC) and the electronic device 404 (e.g., a mobile phone) may start group owner negotiation for forming a standard group. For group owner negotiation, the electronic device 402 and the electronic device 404 may express an intention for a group owner role through a designated numeric value (e.g., an intent value). For example, the electronic device 402 may set its own intent value (e.g., the first intent value) to 4, and the electronic device 404 may set its own intent value (e.g., the second intent value) to 2. In operation 416, the electronic device 402 may transmit negotiation request packets including the first intent value of 5 to an external electronic device (e.g., the electronic device 404) and may receive a negotiation response packet including the second intent value of 2 from the electronic device 404.

In operation 418, as the negotiation response packet is received, the electronic device 402 may identify that the first intent value is larger than the second intent value. Accordingly, the electronic device 402 may determine to serve as a group owner, and the electronic device 404 may determine to serve as a group client. During operation 418, the electronic device 402 and the electronic device 404 may establish a P2P connection for configuring a P2P group according to the group owner role and the group client role.

Referring back to FIG. 3, in operation 304, the first electronic device 310 and the second electronic device 320 may share a file (e.g., music, an image, a document, and/or a video) through a Wi-Fi direct connection. For example, when the file size is 100 MB, it may take 4 to 5 seconds to share the file through the Wi-Fi direct connection.

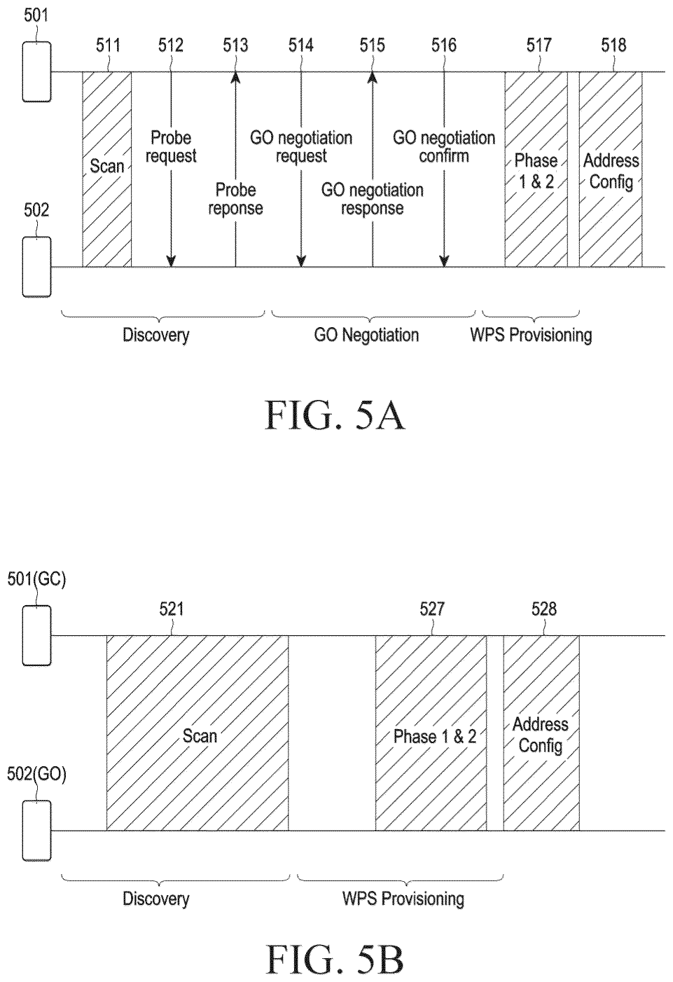

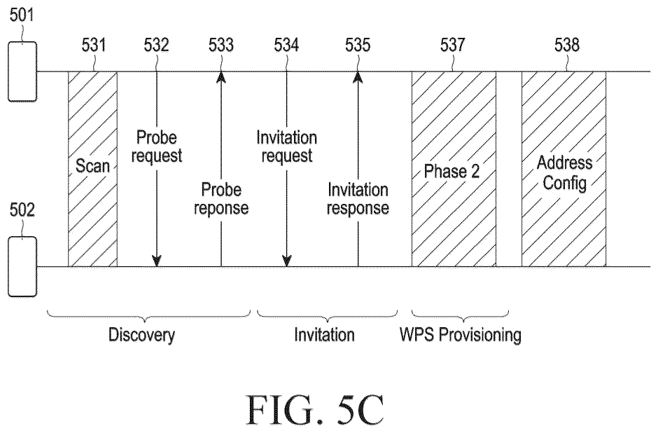

FIGS. 5A to 5C are views illustrating, in greater detail, a P2P group formation procedure according to one or more embodiments. FIG. 5A illustrates a standard group formation procedure, FIG. 5B illustrates an autonomous group formation procedure, and FIG. 5C illustrates a persistent group formation procedure.

Referring to FIG. 5A, the standard group formation procedure may form a group in the order of discovery, group owner (GO) negotiation, Wi-Fi protected setup (WPS) provisioning, and address configuration.

In the discovery process, each of the first electronic device 501 and the second electronic device 502 may discover a counterpart device by performing the scan operation in operation 511, and in operation 512, the first electronic device 501 may establish a channel by transmitting a probe request frame to the second electronic device 502 discovered through the scan operation and receiving a probe response frame from the second electronic device 502.

During the GO negotiation process, the first electronic device 501 and the second electronic device 502 may determine the GO by negotiating the role of the group owner GO and the role of the client GC of the P2P group therebetween. Specifically, in operation 514, the first electronic device 501 may transmit a GO negotiation request frame to the second electronic device 502, in operation 515, the second electronic device 502 may transmit a GO negotiation request frame to the first electronic device 501, and in operation 516, the first electronic device 501 may determine the GO by transmitting a GO negotiation confirm frame to the second electronic device 502. In one or more embodiments, the detailed operation of determining the GO may be performed as shown in FIG. 4.

WPS provisioning in operation 517 may be performed by exchanging personal identification number (PIN) information input through each of the first electronic device 501 and the second electronic device 502 in the WPS, or by configuration such as simple setup through a push button. WPS provisioning may include phase 1 (pre-sharing credential generation) and phase 2 (reconnection, extensible authentication protocol over LAN (EAPOL)).

In operation 518, the first electronic device 501 and the second electronic device 502 may configure a network by being assigned an internet protocol (IP) address through a dynamic host configuration protocol (DHCP) server. The P2P device may allocate and use a P2P interface address using the MAC address within the P2P group session.

The procedure of FIG. 5A may be applied whenever a Wi-Fi direct connection is generated, and this procedure may take 2 to 7 seconds.

Referring to FIG. 5B, the autonomous group forming procedure may form a group in the order of discovery, WPS provisioning, and address configuration.

In the discovery process, each of the first electronic device 501 and the second electronic device 502 may discover a counterpart device by performing the scan operation in operation 521, and in operation 512, the first electronic device 501 may establish a channel by transmitting a probe request frame to the second electronic device 502 discovered through the scan operation and receiving a probe response frame from the second electronic device 502.

WPS provisioning in operation 527 may be performed by exchanging personal identification number (PIN) information input through each of the first electronic device 501 and the second electronic device 502 in the WPS, or by configuration such as simple setup through a push button. WPS provisioning may include phase 1 (pre-sharing credential generation) and phase 2 (reconnection, EAPOL).

In operation 528, the first electronic device 501 and the second electronic device 502 may configure a network by being assigned an IP address through a DHCP server.

When comparing FIG. 5B with FIG. 5A, it may be identified that the GO negotiation operation is omitted in FIG. 5B. In other words, in the autonomous group formation procedure, the first electronic device 501 and the second electronic device 502 do not perform the negotiation process for determining the group owner, and one of the first electronic device 501 and the second electronic device 502 may generate a group on its own and become the owner of the generated group. FIG. 5B illustrates an example in which the second electronic device 502 generates a group and operates as an owner of the generated group, and the first electronic device 501 operates as a group client GC. However, the first electronic device 501 may generate a group and operate as an owner of the generated group, and the second electronic device 502 may operate as a group client.

The autonomous group forming procedure of FIG. 5B may take 2 to 4 seconds.

The persistent group formation procedure is a procedure of forming an initial group and, after a predetermined period of time, attempting the same connection again. Persistent group formation may, when a P2P group is initially formed, store pairing information such as their roles, credential, SSID, P2P group ID, etc. and, upon reconnection, quickly connect the P2P group based on the stored pairing information.

Referring to FIG. 5C, in the discovery process, each of the first electronic device 501 and the second electronic device 502 may discover a counterpart device by performing the scan operation in operation 531, and in operation 532, the first electronic device 501 may establish a channel by transmitting a probe request to the second electronic device 502 and receiving a probe response from the second electronic device 502.

In the persistent group formation procedure, a group owner is already determined when the group is initially formed, so that the GO negotiation operation of FIG. 5A may be omitted, and it is possible to call the already formed P2P group or allow the P2P device to participate in the existing P2P group by performing an invitation process using the pairing information (e.g., their roles in the P2P group, credentials, service set identifier (SSID), or P2P group ID) stored in the initial configuration.

In operation 534, the first electronic device 501 may transmit an invitation request to the second electronic device 502, and in operation 535, the second electronic device 502 may transmit an invitation response to the first electronic device 501. Although FIG. 5C illustrates that the first electronic device 501 transmits an invitation request to the second electronic device 502, the second electronic device 502 may transmit an invitation request to the first electronic device 501, and the first electronic device 501 may transmit an invitation response to the second electronic device 502.

Further, in the standard group formation procedure of FIG. 5A and the autonomous group formation procedure of FIG. 5B, WPS provisioning includes phase 1 (pre-sharing credential generation) and phase 2 (reconnection, EAPOL). However, in the persistent group formation procedure of FIG. 5C, because pairing information (e.g., their roles, credentials, SSIDs, P2P group IDs, etc.) stored at the time of initial group formation is used, phase 1 of WPS provisioning for generating credentials may not be performed, and phase 2 (reconnection, EAPOL) may be performed in operation 537. Therefore, the persistent group formation procedure may form a group faster than the autonomous group formation procedure.

In operation 538, the first electronic device 501 and the second electronic device 502 may configure a network by being assigned an internet protocol (IP) through a dynamic host configuration protocol (DHCP) server.

As such, since GO negotiation and WPS phase 1 are not performed in the persistent group formation procedure, the persistent group formation procedure may establish a P2P connection faster than the standard group formation procedure and the autonomous group formation procedure. For example, the persistent group formation procedure may establish a connection 5 to 6 times faster than the standard group formation procedure or the autonomous group formation procedure, and in this case, the persistent group formation procedure may take about 500 ms.

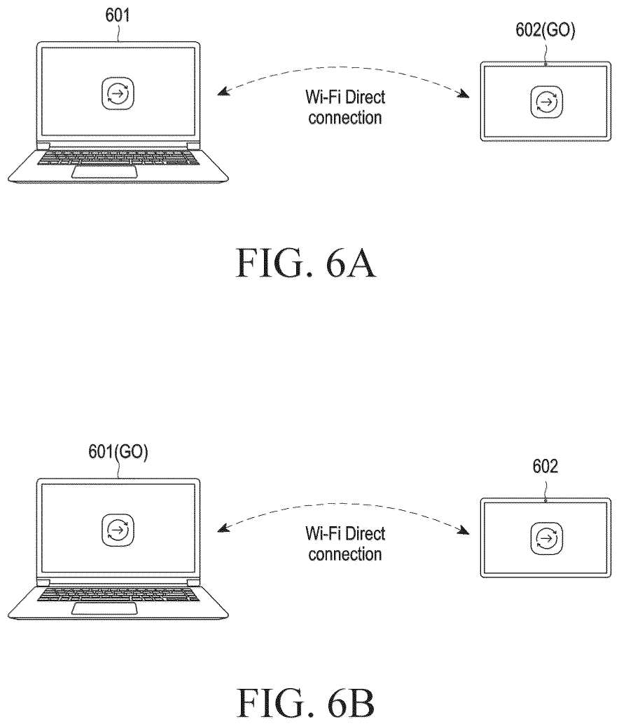

FIGS. 6A and 6B are views illustrating an example of Wi-Fi direct connection based on autonomous group formation.

The first electronic device 601 and the second electronic device 602 may form a group and share function and application context information according to the autonomous group formation procedure of FIG. 5B. The first electronic device 601 and the second electronic device 602 may determine the GO based on the device capability and the application context (transmitter/receiver).

The application context may include information related to an application 212 (e.g., a file sharing application, a multi-control application, or a continuity application) executed by the first electronic device 601 (e.g., the processor 210) and an application 262 (e.g., a file sharing application, a multi-control application, or a continuity application) executed by the second electronic device 602 (e.g., the processor 260) to perform Wi-Fi direct communication.
Device ID [P2P media access control (MAC) address];
Wi-Fi direct connection type [1: Legacy, 2: Non legacy];
Packet info [1: Request, 2: Response, 3: Confirmation]; or
Identity info

In one or more embodiments, the identification information may be determined to be generated by the application 212 of the first electronic device 200 and to be identifiable by the application 262 of the second electronic device 250.

Referring to FIG. 6A, at time T1, the first electronic device 601 as a sender shares a file with the second electronic device 602 through a Wi-Fi direct connection.

The application performing Wi-Fi direct communication in the first electronic device 601 may form an autonomous group with the second electronic device 602 by selecting its role as one of GO or GC based on device capability and application context (transmitter/receiver). FIG. 6A illustrates an example in which the second electronic device 602 operates as a GO. The Wi-Fi direct connection may take 2 to 4 seconds.

Referring to FIG. 6B, at time T2, the second electronic device 602 as a sender shares a file with the first electronic device 601 through a Wi-Fi direct connection.

The application performing Wi-Fi direct communication in the second electronic device 602 may form a new autonomous group with the first electronic device 601 and establish a new Wi-Fi direct connection by selecting its role as one of GO or GC based on device capability and application context (transmitter/receiver). FIG. 6B illustrates an example in which the first electronic device 601 operates as a GO. The new Wi-Fi direct connection may take 2 to 4 seconds.

As such, according to the autonomous group formation procedure, a new group formation procedure should be performed whenever transmitting a file, and each new group formation procedure may take 2 to 4 seconds. This operation may affect the file transfer delay.

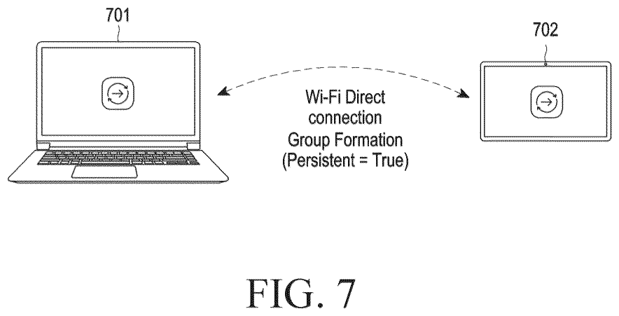

FIG. 7 is a view illustrating an example of Wi-Fi direct connection based on persistent group formation.

The initial group formation may follow the standard group formation procedure of FIG. 5A or the autonomous group formation procedure of FIG. 5B. When the autonomous group formation procedure is followed, initial group formation may take about 2 to 4 seconds.

Since the first electronic device 701 and the second electronic device 702 are already connected after the initial group formation, the subsequent connection may follow the persistent group formation procedure of FIG. 5C. Based on the persistent group formation procedure, it may take about 500 ms to transmit a file in the same application context.

As such, when the persistent group formation procedure is used, the subsequent file transfer time may be reduced in a state in which the Wi-Fi connection configuration remains in the same state.

Meanwhile, when the persistent group formation procedure is used in the subsequent connection, if the Wi-Fi connection configuration (e.g., pairing information such as their roles, credentials, SSIDs, P2P group ID, etc.) is changed, removed from the Wi-Fi framework layer, or the pairing of the Wi-Fi group is released in at least one of the first electronic device or the second electronic device due to external factors such as the operation of another application, the procedure for forming a new group should be performed, and thus a time delay may occur in the Wi-Fi connection.

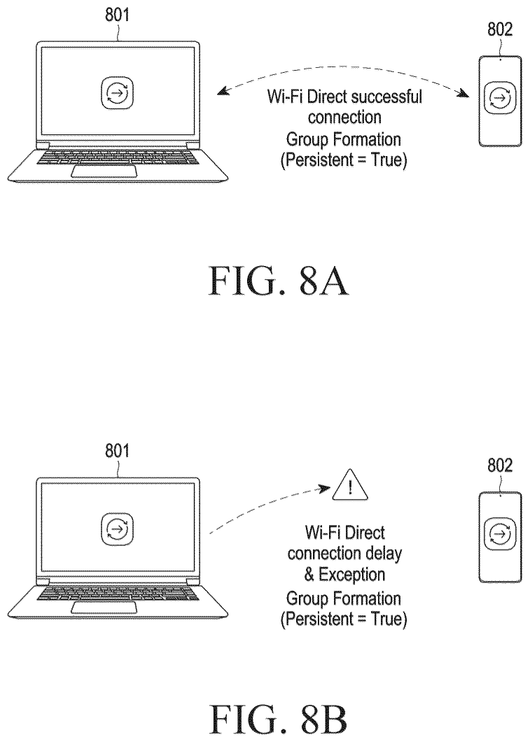

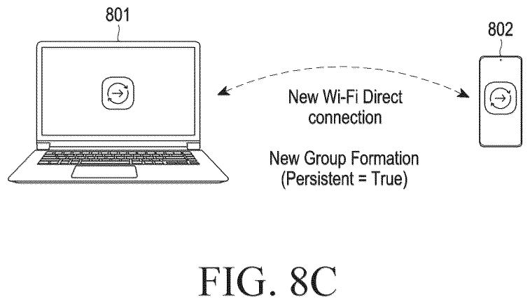

FIGS. 8A and 8B are views illustrating an example of using a persistent group formation procedure in subsequent connection between electronic devices.

Referring to FIG. 8A, at time T1, the first electronic device 801 using the Windows operating system and the second electronic device 802 using the Android operating system may successfully establish an initial Wi-Fi direct connection based on the standard group formation procedure of FIG. 5A or the autonomous group formation procedure of FIG. 5B. The persistent group formation procedure of FIG. 5C may be configured to be used for subsequent connection between the first electronic device 801 and the second electronic device 802.

In one or more embodiments, the previous version of application in the second electronic device 802 may not use the persistent group formation procedure, and the corresponding application may arbitrarily release or remove pairing information to enhance performance. For example, in a situation where a file is additionally shared between the first electronic device 801 and the second electronic device 802, the first electronic device 801 may use persistent group formation for storing credentials in the framework layer, but the second electronic device 802 may store the previous version of application.

Referring to FIG. 8B, at time T2, the second electronic device 802 successfully transmits the file to the first electronic device 801 after initially establishing the Wi-Fi connection, but since it does not support persistent group formation, the second electronic device 802 may automatically release the Wi-Fi connection configuration thereafter. Accordingly, when the first electronic device 801 intends to transmit a file to the second electronic device 802 based on the persistent group formation, an error that the file is not transmitted to the second electronic device 802 may occur.

In this case, the first electronic device 801 needs to form a new P2P group with the second electronic device 802 through an initial Wi-Fi connection establishment procedure at time T3 as shown in FIG. 8C, and the initial Wi-Fi connection establishment may take 2 to 4 seconds.

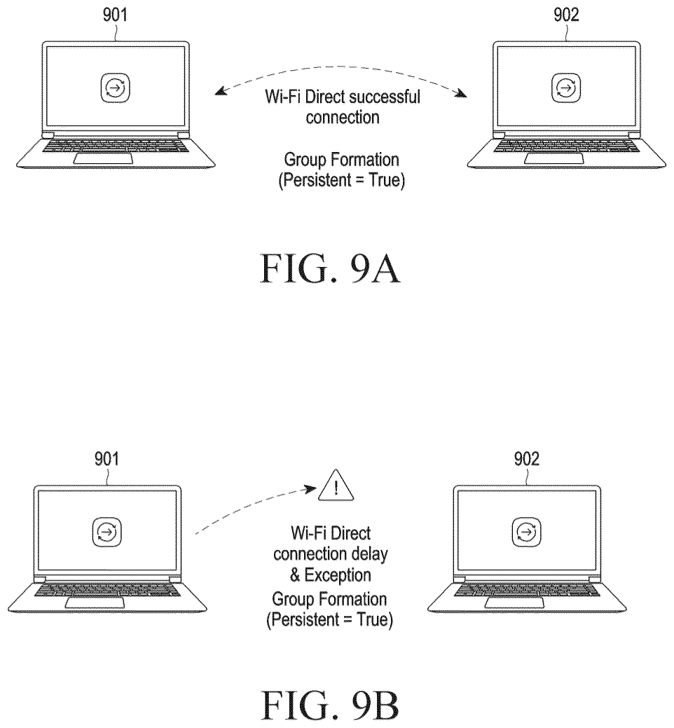

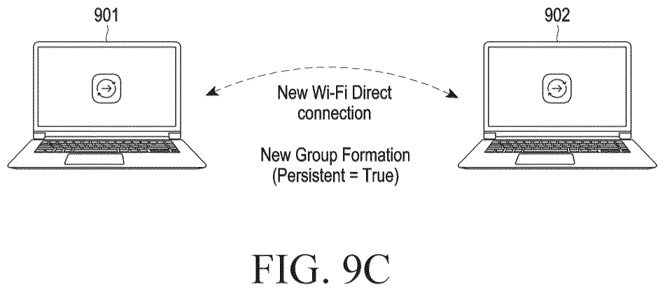

FIGS. 9A and 9B are views illustrating another example of using a persistent group formation procedure in subsequent connection between electronic devices.

Referring to FIG. 9A, at time T1, the first electronic device 801 using the Windows operating system and the second electronic device 802 using the Windows operating system may successfully establish an initial Wi-Fi direct connection based on the standard group formation procedure of FIG. 5A or the autonomous group formation procedure of FIG. 5B. The persistent group formation procedure of FIG. 5C may be configured to be used for subsequent connection between the first electronic device 801 and the second electronic device 802.

In one or more embodiments, the second electronic device 802 may use another application for changing the P2P group formation with the first electronic device 801 or releasing pairing. In this case, the first electronic device 801 may not know whether the pairing information in the second electronic device 802 is changed or released. Accordingly, as illustrated in FIG. 9B, at time T2, the first electronic device 801 attempts to transmit a file to the second electronic device 802 using previously stored pairing information (e.g., their roles, credentials, SSID, P2P group ID, etc.) based on the persistent group formation, but an error that the file is not transmitted to the second electronic device 802 may occur.

In this case, the first electronic device 801 needs to form a new P2P group with the second electronic device 802 through an initial Wi-Fi connection establishment procedure at time T3 as shown in FIG. 9C, and the initial Wi-Fi connection establishment may take 2 to 4 seconds.

As illustrated in FIGS. 8A to 9C, when one of the electronic devices included in the P2P group changes or deletes pairing information stored in the Wi-Fi framework layer in the persistent group formation, a subsequent connection attempt by the other electronic device fails. In one or more embodiments, when both the electronic devices included in the P2P group use the Windows operating system, the subsequent connection attempt may take 1-2 seconds. In one or more embodiments, when the electronic device using the Windows operating system and the electronic device using the Android operating system form a P2P group, the subsequent connection attempt may take 7-10 seconds. It may also take 2-4 seconds to establish a new connection after the subsequent connection attempt fails. Therefore, as the time required for completing the subsequent connection, 4-6 seconds and 8-12 seconds may be required for connection between electronic devices using the Windows operating system and connection between an electronic device using the Windows operating system and an electronic device using the Android operating system, respectively.

Therefore, the disclosure proposes a method for reducing a delay time generated in a subsequent connection between electronic devices based on persistent group formation.

According to the disclosure, it is possible to identify whether the Wi-Fi configuration is changed by identifying pairing information (e.g., their roles, credentials, SSID, P2P group ID, etc.) stored between electronic devices included in the P2P group before performing the persistent group formation procedure. If it is identified that the Wi-Fi configuration is changed in at least one electronic device included in the P2P group, the counterpart electronic device may start a new connection procedure without performing a connection attempt using the previous connection information. When the connection procedure according to the disclosure is used, 1-2 seconds may be saved in the connection between the electronic devices based on the Windows operating system as shown in FIGS. 8, and 7-10 seconds may be saved in the connection between the electronic device based on the Windows operating system and the electronic device based on the Android operating system as shown in FIG. 9.

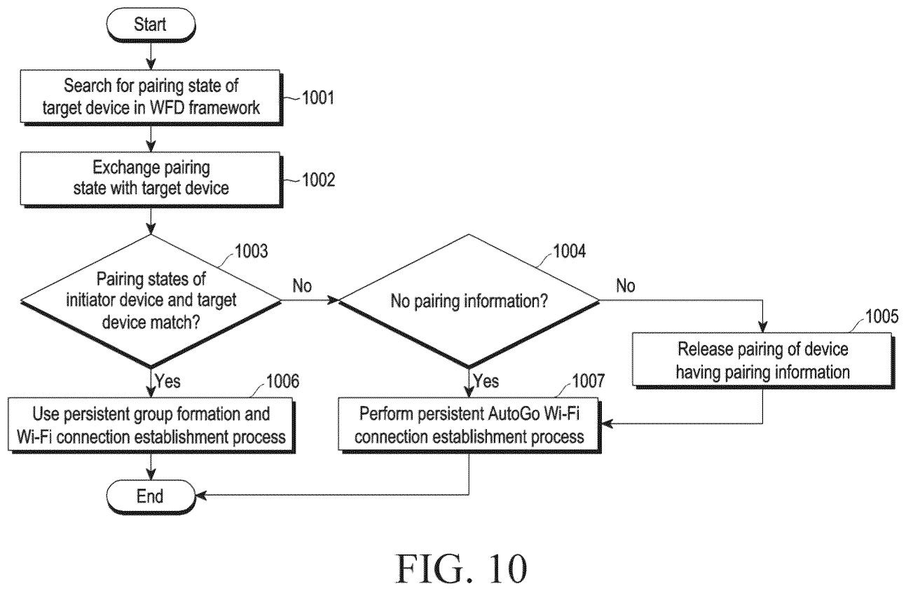

FIG. 10 is a view illustrating a persistent group formation procedure according to one or more embodiments. According to one or more embodiments, at least one of operations to be described below may be executed by the first electronic device 200 (e.g., the processor 210). According to embodiments, at least one of operations to be described below may be omitted, modified, or executed in a different order.

Referring to FIG. 10, when the first electronic device, which is the initiator for initiating the Wi-Fi direct connection, is already paired with the second electronic device, which is the target device of the P2P group, in the application layer, the first electronic device may search for the pairing state of the second electronic device in the Wi-Fi direct framework layer in operation 1001.

In operation 1002, the first electronic device may exchange the pairing state with the second electronic device. In one or more embodiments, the first electronic device may exchange pairing information (e.g., their roles, credentials, SSID, P2P group ID, etc.) with the second electronic device through Bluetooth (BT) or Bluetooth low energy (BLE).

In operation 1003, the first electronic device may identify whether the pairing state of the second electronic device matches its own pairing state.

When the pairing states of the first electronic device and the second electronic device match, in operation 1006, the first electronic device may perform a persistent group formation procedure and may perform a Wi-Fi connection establishment process with the second electronic device based on the procedure illustrated in FIG. 5C.

When the pairing states of the two electronic devices do not match, in operation 1004, the first electronic device may identify whether pairing information for the second electronic device exists.

When there is no pairing information for the second electronic device, in operation 1007, the first electronic device may perform a Wi-Fi connection establishment process based on the autonomous group formation procedure as illustrated in FIG. 5B.

When the pairing information for the second electronic device exists in the first electronic device, the pairing information about the second electronic device may be changed or deleted. In this case, in operation 1005, the first electronic device may release pairing with the second electronic device in the Wi-Fi direct framework layer, and may perform the Wi-Fi connection establishment process based on the autonomous group formation procedure as illustrated in FIG. 5B for new connection establishment with the second electronic device.

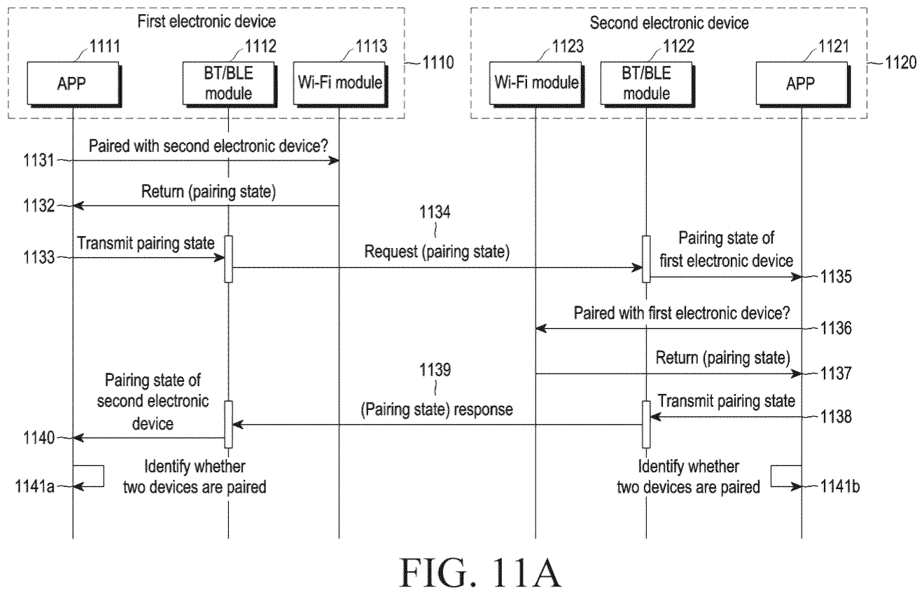

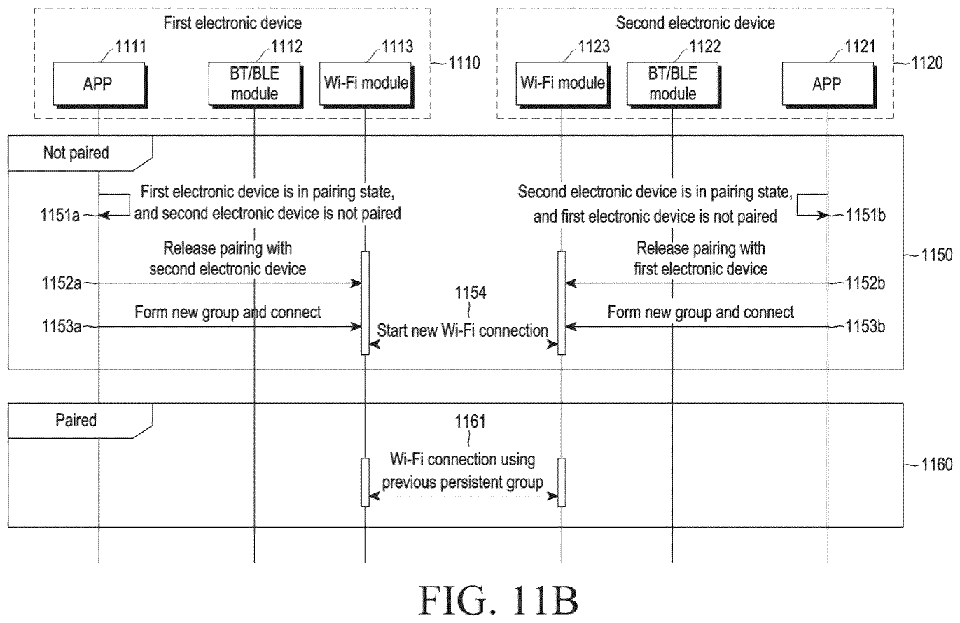

FIGS. 11A and 11B are sequence diagrams illustrating a persistent group formation procedure according to one or more embodiments. In FIG. 11, it is assumed that the first electronic device 1110 and the second electronic device 1120 have already been paired. According to embodiments, at least one of operations to be described below may be omitted, modified, or executed in a different order.

Referring to FIGS. 11A and 11B, in operation 1131, the application 1111 (e.g., the application 212 or 1111 executed by the processor 210) of the first electronic device 1110 may request the Wi-Fi module 1113 to identify the pairing state with the second electronic device 1120. In one or more embodiments, when Wi-Fi reconnection with the second electronic device 1120 is required based on the execution of the application 1111 (e.g., a file sharing application, a multi-control application, or a continuity application) using Wi-Fi direct communication, the first electronic device 1110 (e.g., the processor 210) may request the Wi-Fi module 1113 to identify the pairing state with the second electronic device 1120.

In operation 1132, the first electronic device 1110 (e.g., the Wi-Fi module 1113) may return the pairing state for the second electronic device 1120 to the application 1111.

In operation 1133, the first electronic device 1110 (e.g., the application 1111) may transmit the pairing state for the second electronic device 1120 to the BT/BLE module 1112. In operation 1134, the first electronic device 1110 (e.g., the BT/BLE module 1112) may request pairing state information from the second electronic device 1120. In one or more embodiments, the first electronic device 1110 may transmit the pairing state information about the first electronic device 1110, together with the pairing state information request, to the second electronic device 1120.

In operation 1135, the second electronic device 1120 (e.g., the BT/BLE module 1122) may transmit the pairing state information about the first electronic device to the application 1121 based on the pairing state information being requested and the pairing state information about the first electronic device 1110 being received from the first electronic device 1110.

In operation 1136, the second electronic device 1120 (e.g., the application 1121) may request the Wi-Fi module 1123 to identify the pairing state with the first electronic device 1110.

In operation 1136, the second electronic device 1120 (e.g., the Wi-Fi module 1123) may return the pairing state of the first electronic device 1110 to the application 1121.

In operation 1137, the second electronic device 1120 (e.g., the application 1121) may transmit the pairing state of the first electronic device 1110 to the BT/BLE module 1122. In operation 1138, the second electronic device 1120 (e.g., the BT/BLE module 1122) may transmit a response to the pairing state information request to the first electronic device 1110. In one or more embodiments, the second electronic device 1120 may transmit the pairing state information about the second electronic device 1120, together with the pairing state information request, to the first electronic device 1110.

In operation 1141a, the first electronic device 1110 (e.g., the application 1111) may identify whether the first electronic device 1110 is paired with the second electronic device 1120, based on the pairing information received from the second electronic device 1120. In one or more embodiments, the first electronic device 1110 may compare the pairing information about the second electronic device 1120 stored in the first electronic device 1110 with the pairing information received from the second electronic device 1120, and when it is determined that the two pieces of information are the same as a result of the comparison, the first electronic device 1110 may determine that the electronic devices are paired. In one or more embodiments, the first electronic device 1110 may compare the pairing information about the second electronic device 1120 stored in the first electronic device 1110 with the pairing information received from the second electronic device 1120, and when it is determined that the two pieces of information are not the same as a result of the comparison, the first electronic device 1110 may determine that the electronic devices are not paired.

In operation 1141b, the second electronic device 1120 (e.g., the application 1121) may identify whether the second electronic device 1120 is paired with the first electronic device 1110, based on the pairing information received from the first electronic device 1110. In one or more embodiments, the second electronic device 1120 may compare the pairing information about the first electronic device 1110 stored in the second electronic device 1120 with the pairing information received from the first electronic device 1110, and when it is determined that the two pieces of information are the same as a result of the comparison, the first electronic device 1110 may determine that the electronic devices are paired. In one or more embodiments, the second electronic device 1120 may compare the pairing information about the first electronic device 1110 stored in the second electronic device 1120 with the pairing information received from the first electronic device 1110, and when it is determined that the two pieces of information are not the same as a result of the comparison, the first electronic device 1110 may determine that the electronic devices are not paired.

When it is determined that the first electronic device 1110 and the second electronic device 1120 are paired, in operation 1161, the first electronic device (e.g., the Wi-Fi module 1113) and the second electronic device (e.g., the Wi-Fi module 1123) may establish the Wi-Fi connection based on the persistent group formation procedure of FIG. 5C.

When it is determined that the first electronic device 1110 and the second electronic device 1120 are not paired, the first electronic device 1110 and the second electronic device 1120 may establish a new Wi-Fi connection by performing operations 1150.

In operation 1151a, the first electronic device 1110 (e.g., the application 1111) may determine that the first electronic device 1110 is in the pairing state and the second electronic device 1120 is not paired, and in operation 1152a, request the Wi-Fi module 1113 to release the pairing with the second electronic device 1120.

In operation 1153a, the first electronic device 1110 (e.g., the application 1111) may request the Wi-Fi module 1113 to form a new group and establish a Wi-Fi connection with the second electronic device 1120.

In operation 1151b, the second electronic device 1120 (e.g., the application 1121) may determine that the second electronic device 1120 is in the pairing state and the first electronic device 1110 is not paired, and in operation 1152b, request the Wi-Fi module 1123 to release the pairing with the first electronic device 1110.

In operation 1153b, the second electronic device 1120 (e.g., the application 1121) may request the Wi-Fi module 1123 to form a new group and establish a Wi-Fi connection with the first electronic device 1110.

In operation 1154, the first electronic device 1110 (e.g., the Wi-Fi module 1113) and the second electronic device 1120 (e.g., the Wi-Fi module 1123) may perform a procedure for forming a new group and establishing a Wi-Fi connection. The new group formation procedure may follow the standard group formation procedure of FIG. 5A or the autonomous group formation procedure of FIG. 5B.

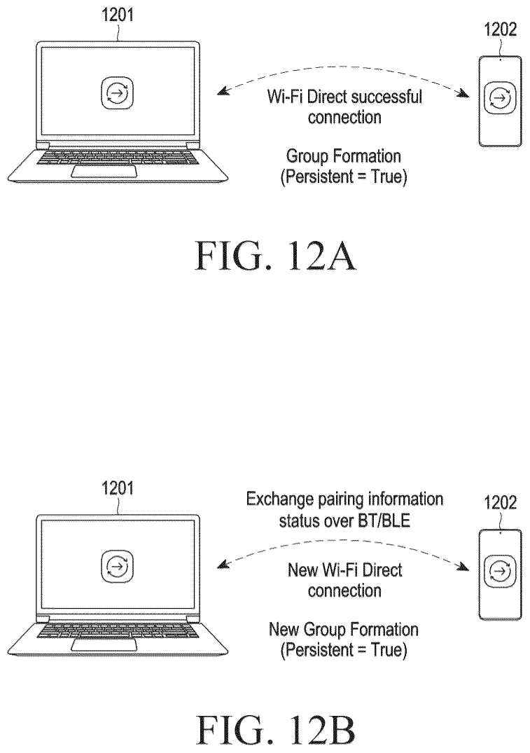

FIGS. 12A and 12B are views illustrating an example of using a persistent group formation procedure in subsequent connection between electronic devices according to one or more embodiments.

Referring to FIG. 12A, at time T1, the first electronic device 1201 using the Windows operating system and the second electronic device 1202 using the Android operating system may successfully establish an initial Wi-Fi direct connection and share files based on the standard group formation procedure of FIG. 5A or the autonomous group formation procedure of FIG. 5B. The persistent group formation procedure of FIG. 5C may be configured to be used for subsequent connection between the first electronic device 1201 and the second electronic device 1202.

In one or more embodiments, the previous version of application in the second electronic device 1202 may not use the persistent group formation procedure, and the corresponding application may arbitrarily release or remove pairing information to enhance performance. For example, the first electronic device 1201 may use persistent group formation for storing credentials in the framework layer, but the second electronic device 1202 may store a previous version of application. Accordingly, the second electronic device 1202 may release pairing with the first electronic device 1201 after file sharing.

Referring to FIG. 12B, at time T2, the first electronic device 1201 may share a file with the second electronic device 1202, and may identify the pairing state of the counterpart device by exchanging pairing state information with the second electronic device 1202 through the BT/BLE module based on the procedure illustrated in FIGS. 10, 11A, and 11B before performing the persistent group formation procedure.

When it is determined to be not in the pairing state based on the exchanged pairing state information, the first electronic device 1201 may release the pairing with the second electronic device 1202 and may perform a new Wi-Fi direct group formation procedure with the second electronic device 1202. In this case, compared to the examples illustrated in FIGS. 8A to 8C, the time required for establishing a new Wi-Fi direct connection may be reduced by 7 to 10 seconds.

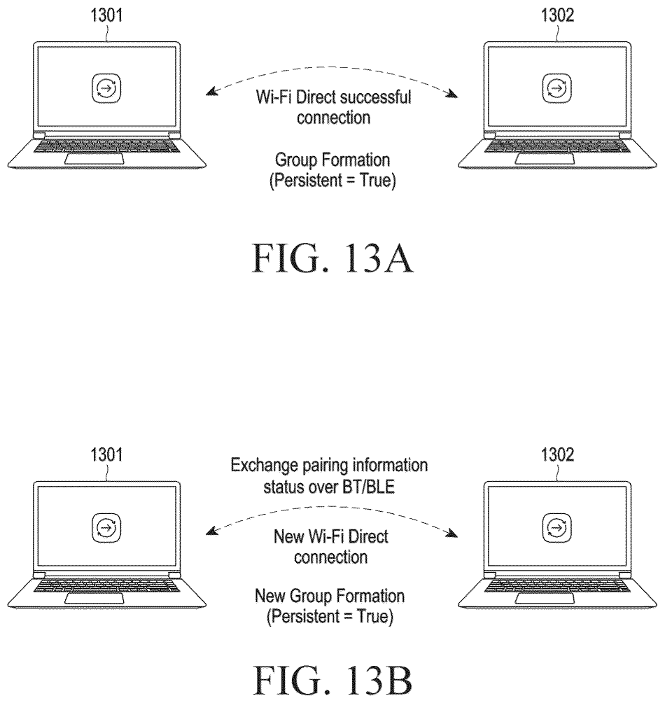

FIGS. 13A and 13B are views illustrating an example of using a persistent group formation procedure in subsequent connection between electronic devices according to one or more embodiments.

Referring to FIG. 13A, at time T1, the first electronic device 1301 using the Windows operating system and the second electronic device 1302 using the Windows operating system may successfully establish an initial Wi-Fi direct connection based on the standard group formation procedure of FIG. 5A or the autonomous group formation procedure of FIG. 5B. The persistent group formation procedure of FIG. 5C may be configured to be used for subsequent connection between the first electronic device 1301 and the second electronic device 1302.

In one or more embodiments, the second electronic device 1302 may use another application for changing the P2P group formation with the first electronic device 1301 or releasing pairing.

Referring to FIG. 13B, at time T2, the first electronic device 1301 may share a file with the second electronic device 1302, and may identify the pairing state of the counterpart device by exchanging pairing state information with the second electronic device 1302 through the BT/BLE module based on the procedure illustrated in FIGS. 10, 11A, and 11B before performing the persistent group formation procedure.

When it is determined to be not in the pairing state based on the exchanged pairing state information, the first electronic device 1301 may release the pairing with the second electronic device 1302 and may perform a new Wi-Fi direct group formation procedure with the second electronic device 1302. In this case, compared to the examples illustrated in FIGS. 9A to 9C, the time required for establishing a new Wi-Fi direct connection may be reduced by 1 to 2 seconds.

An electronic device according to one or more embodiments may comprise a communication circuit including a Bluetooth communication module and a Wi-Fi module, and at least one processor. The at least one processor may be configured to identify pairing state information related to a Wi-Fi direct connection between an external electronic device and the electronic device, transmit a pairing state request including pairing state information about the electronic device to the external electronic device through the Bluetooth communication module, receive a pairing state response to the pairing state request from the external electronic device through the Bluetooth communication module, release the Wi-Fi direct connection between the external electronic device and the electronic device based on a result of comparison between pairing state information about the external electronic device included in the pairing state response and the pairing state information about the electronic device, generate a new group for a new Wi-Fi direct connection to the external electronic device, and establish a Wi-Fi direct peer-to-peer (P2P) connection based on the generated new group with the external electronic device through the Wi-Fi module.

In one or more embodiments, the at least one processor may release the Wi-Fi direct connection between the external electronic device and the electronic device based on the pairing state information about the external electronic device being different from the pairing state information about the electronic device.

In one or more embodiments, the at least one processor may persist in a Wi-Fi direct P2P connection using the Wi-Fi direct connection between the external electronic device and the electronic device based on the pairing state information about the external electronic device being identical to the pairing state information about the electronic device.

In one or more embodiments, the pairing state information may include at least one of a role in the group for the Wi-Fi direct connection, a credential, a service set identifier (SSID)), and a group ID for the Wi-Fi direct connection.

In one or more embodiments, the at least one processor may obtain the pairing state information from the Wi-Fi module through an application using the Wi-Fi direct connection.

In one or more embodiments, the at least one processor may
generate the new group for the new Wi-Fi direct connection with the external electronic device based on a persistent group formation procedure.

In one or more embodiments, the at least one processor may
generate the group for the Wi-Fi direct connection between the external electronic device and the electronic device based on a persistent group formation procedure.

A method performed by an electronic device according to one or more embodiments may comprise identifying pairing state information related to a Wi-Fi direct connection between an external electronic device and the electronic device, transmitting a pairing state request including pairing state information about the electronic device to the external electronic device through a Bluetooth communication module of a communication circuit, receiving a pairing state response to the pairing state request from the external electronic device through the Bluetooth communication module, releasing the Wi-Fi direct connection between the external electronic device and the electronic device based on a result of comparison between pairing state information about the external electronic device included in the pairing state response and the pairing state information about the electronic device, generating a new group for a new Wi-Fi direct connection to the external electronic device, and establishing a Wi-Fi direct peer-to-peer (P2P) connection based on the generated new group with the external electronic device through a Wi-Fi module of the communication circuit.

In one or more embodiments, the method may further comprise releasing the Wi-Fi direct connection between the external electronic device and the electronic device based on the pairing state information about the external electronic device being different from the pairing state information about the electronic device.

In one or more embodiments, the method may further comprise persisting in (maintaining) a Wi-Fi direct P2P connection using the Wi-Fi direct connection between the external electronic device and the electronic device based on the pairing state information about the external electronic device being identical to the pairing state information about the electronic device.

In one or more embodiments, the pairing state information may include at least one of a role in the group for the Wi-Fi direct connection, a credential, a service set identifier (SSID), and a group ID for the Wi-Fi direct connection.

In one or more embodiments, the method may further comprise obtaining the pairing state information from the Wi-Fi module through an application using the Wi-Fi direct connection.

In one or more embodiments, the method may comprise generating the new group for the new Wi-Fi direct connection with the external electronic device based on a persistent group formation procedure.

In one or more embodiments, the method may further comprise generating the group for the Wi-Fi direct connection between the external electronic device and the electronic device based on a persistent group formation procedure.

A non-transitory computer-readable storage medium storing one or more programs, according to one or more embodiments, may comprise instructions to, when executed by at least one processor of an electronic device, enable the electronic device to: identify pairing state information related to a Wi-Fi direct connection between an external electronic device and the electronic device, transmit a pairing state request including pairing state information about the electronic device to the external electronic device through a Bluetooth communication module, receive a pairing state response to the pairing state request from the external electronic device through the Bluetooth communication module, release the Wi-Fi direct connection between the external electronic device and the electronic device based on a result of comparison between pairing state information about the external electronic device included in the pairing state response and the pairing state information about the electronic device, generate a new group for a new Wi-Fi direct connection to the external electronic device, and establish a Wi-Fi direct peer-to-peer connection based on the generated new group with the external electronic device through a Wi-Fi module.

In one or more embodiments, the one or more programs may comprise instructions configured to enable the electronic device to release the Wi-Fi direct connection between the external electronic device and the electronic device based on the pairing state information about the external electronic device being different from the pairing state information about the electronic device.

In one or more embodiments, the one or more programs may comprise instructions configured to enable the electronic device to persist in a Wi-Fi direct P2P connection using the Wi-Fi direct connection between the external electronic device and the electronic device based on the pairing state information about the external electronic device being identical to the pairing state information about the electronic device.

In one or more embodiments, the pairing state information may include at least one of a role in the group for the Wi-Fi direct connection, a credential, a service set identifier (SSID), and a group ID for the Wi-Fi direct connection.

In one or more embodiments, the one or more programs may comprise instructions configured to enable the electronic device to obtain the pairing state information from the Wi-Fi module through an application using the Wi-Fi direct connection.

In one or more embodiments, the one or more programs may comprise instructions configured to enable the electronic device to generate the new group for the new Wi-Fi direct connection with the external electronic device based on a persistent group formation procedure.

The electronic device according to various embodiments of the disclosure may be one of various types of electronic devices. The electronic devices may include, for example, a portable communication device (e.g., a smart phone), a computer device, a portable multimedia device, a portable medical device, a camera, a wearable device, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

One or more embodiments of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a Bluetooth communication interface;
a Wi-Fi interface;
memory storing instructions;
at least one processor configured to execute the instructions,
wherein the instructions, when executed by the at least one processor individually or collectively, cause the electronic device to:
identify Wi-Fi pairing state information related to a Wi-Fi direct connection between an external electronic device and the electronic device;
transmit a pairing state request comprising electronic device pairing state information about the electronic device to the external electronic device through the Bluetooth communication interface;
receive a pairing state response to the pairing state request from the external electronic device through the Bluetooth communication interface, the pairing state response comprising external electronic device pairing state information about the external electronic device;
compare the external electronic device pairing state information and the electronic device pairing state information;
release the Wi-Fi direct connection between the external electronic device and the electronic device based on a result of the comparison;
generate a new group for a new Wi-Fi direct connection to the external electronic device; and
establish a Wi-Fi direct peer-to-peer (P2P) connection with the external electronic device through the Wi-Fi interface, based on the generated new group.

2. The electronic device of claim 1, wherein the instructions, when executed by the at least one processor individually or collectively, further cause the electronic device to release the Wi-Fi direct connection between the external electronic device and the electronic device based on the external electronic device pairing state information being different from the electronic device pairing state information.

3. The electronic device of claim 1, wherein the instructions, when executed by the at least one processor individually or collectively, further cause the electronic device to, based on the external electronic device pairing state information being the same as the electronic device pairing state information, maintain the Wi-Fi direct P2P connection using a group for the Wi-Fi direct connection between the external electronic device and the electronic device.

4. The electronic device of claim 3, wherein the Wi-Fi pairing state information comprises at least one of a role in the group for the Wi-Fi direct connection, a credential, a service set identifier (SSID), or a group ID for the Wi-Fi direct connection.

5. The electronic device of claim 1, wherein the instructions, when executed by the at least one processor individually or collectively, further cause the electronic device to obtain the Wi-Fi pairing state information from the Wi-Fi interface through an application using the Wi-Fi direct connection.

6. The electronic device of claim 1, wherein the instructions, when executed by the at least one processor individually or collectively, further cause the electronic device to generate the new group for the new Wi-Fi direct connection with the external electronic device based on a persistent group formation procedure.

7. The electronic device of claim 3, wherein the instructions, when executed by the at least one processor individually or collectively, further cause the electronic device to generate the group for the Wi-Fi direct connection between the external electronic device and the electronic device based on a persistent group formation procedure.

8. A method performed by an electronic device, the method comprising:
identifying Wi-Fi pairing state information related to a Wi-Fi direct connection between an external electronic device and the electronic device;
transmitting a pairing state request comprising electronic device pairing state information about the electronic device to the external electronic device through a Bluetooth communication interface;
receiving a pairing state response to the pairing state request from the external electronic device through the Bluetooth communication interface, the pairing state response comprising external electronic device pairing state information about the external electronic device;
comparing the external electronic device pairing state information and the electronic device pairing state information to generate a comparison result;
releasing the Wi-Fi direct connection between the external electronic device and the electronic device based on a result of the comparing;
generating a new group for a new Wi-Fi direct connection to the external electronic device; and
establishing a Wi-Fi direct peer-to-peer (P2P) connection with the external electronic device through a Wi-Fi interface, based on the generated new group.

9. The method of claim 8, further comprising releasing the Wi-Fi direct connection between the external electronic device and the electronic device based on the external electronic device pairing state information being different from the electronic device pairing state information.

10. The method of claim 8, further comprising, based on the external electronic device pairing state information being the same as the electronic device pairing state information, maintaining the Wi-Fi direct P2P connection using a group for the Wi-Fi direct connection between the external electronic device and the electronic device.

11. The method of claim 10, wherein the Wi-Fi pairing state information comprises at least one of a role in the group for the Wi-Fi direct connection, a credential, a service set identifier (SSID), or a group ID for the Wi-Fi direct connection.

12. The method of claim 8, further comprising obtaining the Wi-Fi pairing state information from the Wi-Fi interface through an application using the Wi-Fi direct connection.

13. The method of claim 8, further comprising generating the new group for the new Wi-Fi direct connection with the external electronic device based on a persistent group formation procedure.

14. The method of claim 10, further comprising generating the group for the Wi-Fi direct connection between the external electronic device and the electronic device based on a persistent group formation procedure.

15. A non-transitory computer-readable storage medium storing one or more programs comprising instructions to, when executed by at least one processor of an electronic device individually or collectively, cause the electronic device to:
identify Wi-Fi pairing state information related to a Wi-Fi direct connection between an external electronic device and the electronic device;
transmit a pairing state request comprising electronic device pairing state information about the electronic device to the external electronic device through a Bluetooth communication interface;
receive a pairing state response to the pairing state request from the external electronic device through the Bluetooth communication interface, the pairing state response comprising external electronic device pairing state information about the external electronic device;
compare the external electronic device pairing state information and the electronic device pairing state information to generate a comparison result;
release the Wi-Fi direct connection between the external electronic device and the electronic device based on the comparison result;
generate a new group for a new Wi-Fi direct connection to the external electronic device; and
establish a Wi-Fi direct peer-to-peer (P2P) connection with the external electronic device through a Wi-Fi interface, based on the generated new group.

16. The non-transitory computer-readable storage medium of claim 15, wherein the instructions further cause the electronic device to release the Wi-Fi direct connection between the external electronic device and the electronic device based on the external electronic device pairing state information being different from the electronic device pairing state information.

17. The non-transitory computer-readable storage medium of claim 15, wherein the instructions further cause the electronic device to, based on the external electronic device pairing state information being same as the electronic device pairing state information, maintain the Wi-Fi direct P2P connection using a group for the Wi-Fi direct connection between the external electronic device and the electronic device.

18. The non-transitory computer-readable storage medium of claim 17, wherein the Wi-Fi pairing state information comprises at least one of a role in the group for the Wi-Fi direct connection, a credential, a service set identifier (SSID), or a group ID for the Wi-Fi direct connection.

19. The non-transitory computer-readable storage medium of claim 15, wherein the instructions further cause the electronic device to obtain the Wi-Fi pairing state information from the Wi-Fi interface through an application using the Wi-Fi direct connection.

20. The non-transitory computer-readable storage medium of claim 15, wherein the instructions further cause the electronic device to generate the new group for the new Wi-Fi direct connection with the external electronic device based on a persistent group formation procedure.
